(19) United States
(12) Patent Application Publication
(10) Pub. No.: US 2026/0129056 A1
(43) Pub. Date: May 7, 2026

(54) PROXY DEVICES FOR MOVING ACROSS CARD NETWORKS

(71) Applicant: Capital One Services, LLC, McLean, VA (US)

(72) Inventors: Ian OROURKE, Washington, DC (US); Timothy E. EMERSON, Ashburn, VA (US); Walker MARSH, Brooklyn, NY (US)

(21) Appl. No.: 18/938,727

(22) Filed: Nov. 6, 2024

(51) Int. Cl. H04L 9/40

(52) U.S. Cl. CPC H04L 63/1416; H04L 63/0414; H04L 63/08

(57) ABSTRACT

In some implementations, a proxy device, configured to receive requests on behalf of a first card network, may receive a request to authorize an event. The request may include a virtual identifier that is associated with the first card network. The proxy device may map the virtual identifier to a permanent identifier that is associated with a second card network different from the first card network. The proxy device may replace the virtual identifier in the request with the permanent identifier in order to generate a detokenized request. The proxy device may transmit the detokenized request to the second card network for processing.

### BACKGROUND

To improve security in a computerized system, virtual identifiers may be used in place of permanent identifiers. For example, a virtual card number (VCN) may be used in place of a payment account number (PAN). Tokenizing the PAN into the VCN improves security because the VCN may be replaced, if compromised, more easily than the PAN.

### SUMMARY

Some implementations described herein relate to a system for routing requests across card networks. The system may include one or more memories and one or more processors communicatively coupled to the one or more memories. The one or more processors may be configured to receive a request to authorize an event, wherein the request includes a virtual identifier that is associated with a first card network, wherein the system is configured to receive requests on behalf of the first card network. The one or more processors may be configured to map the virtual identifier to a permanent identifier that is associated with a second card network different from the first card network. The one or more processors may be configured to reencode the request into an envelope, using the permanent identifier instead of the virtual identifier, that is transparent to the second card network. The one or more processors may be configured to transmit the envelope to the second card network for processing.

Some implementations described herein relate to a method of routing requests across card networks. The method may include receiving, at a proxy device configured to receive requests on behalf of a first card network, a request to authorize an event, wherein the request includes a virtual identifier that is associated with the first card network. The method may include mapping, by the proxy device, the virtual identifier to a permanent identifier that is associated with a second card network different from the first card network. The method may include replacing, by the proxy device, the virtual identifier in the request with the permanent identifier in order to generate a detokenized request. The method may include transmitting, from the proxy device, the detokenized request to the second card network for processing.

Some implementations described herein relate to a non-transitory computer-readable medium that stores a set of instructions for generating a virtual identifier that routes across card networks. The set of instructions, when executed by one or more processors of a device, may cause the device to receive a request to link a virtual identifier, associated with a first card network, to a permanent identifier that is associated with a second card network different from the first card network. The set of instructions, when executed by one or more processors of the device, may cause the device to generate a data structure that stores the virtual identifier in association with the permanent identifier. The set of instructions, when executed by one or more processors of the device, may cause the device to transmit the data structure to a detokenizer device associated with a proxy device of the first card network.

### BRIEF DESCRIPTION OF THE DRAWINGS

FIGS. 1A-1F are diagrams of an example implementation relating to moving across card networks, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIG. 4 is a flowchart of an example process relating to moving across card networks, in accordance with some embodiments of the present disclosure.

FIG. 5 is a flowchart of an example process relating to generating virtual identifiers across card networks, in accordance with some embodiments of the present disclosure.

### DETAILED DESCRIPTION

The following detailed description of example implementations refers to the accompanying drawings. The same reference numbers in different drawings may identify the same or similar elements.

To improve security in a computerized system, virtual identifiers may be used in place of permanent identifiers. For example, a VCN may be used in place of a PAN. Tokenizing the PAN into the VCN improves security because the VCN may be replaced, if compromised, more easily than the PAN. As a result, computer resources are conserved.

Generally, a VCN is detokenized (e.g., into a PAN) at an issuing device. Therefore, a request (e.g., for a transaction or another type of event) is routed from an acquiring device to the issuing device, via a card network, using the VCN. As a result, the VCN generally has to be associated with a same card network as the PAN to which the VCN maps.

Some implementations described herein enable a proxy device, associated with a card network, to detokenize a virtual identifier into a permanent identifier, before a request including the virtual identifier (e.g., for a transaction or another type of event) is routed through the card network. Therefore, the proxy device may route the request to a different card network after detokenization. As a result, security may be further improved because a virtual identifier may be used that is associated with a different card network than a card network associated with a permanent identifier to which the virtual identifier maps.

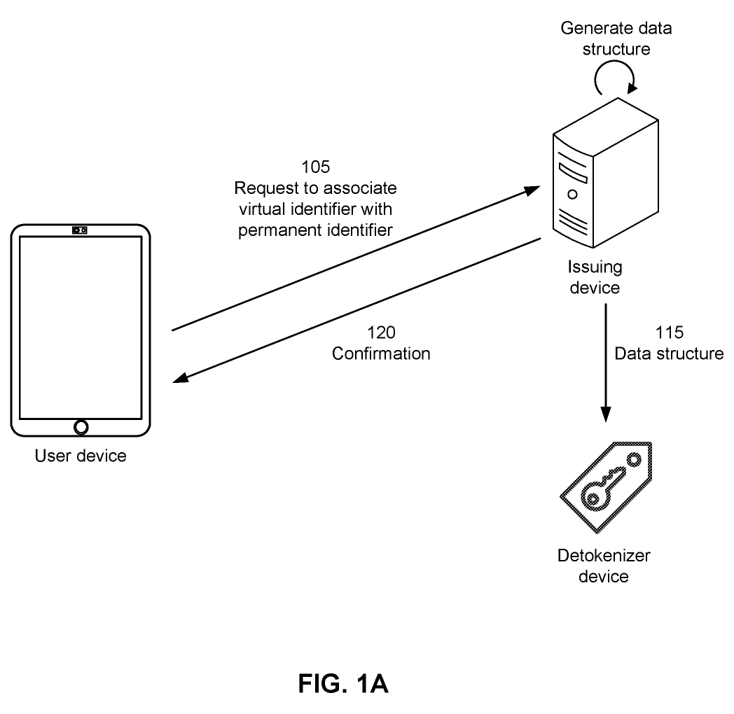

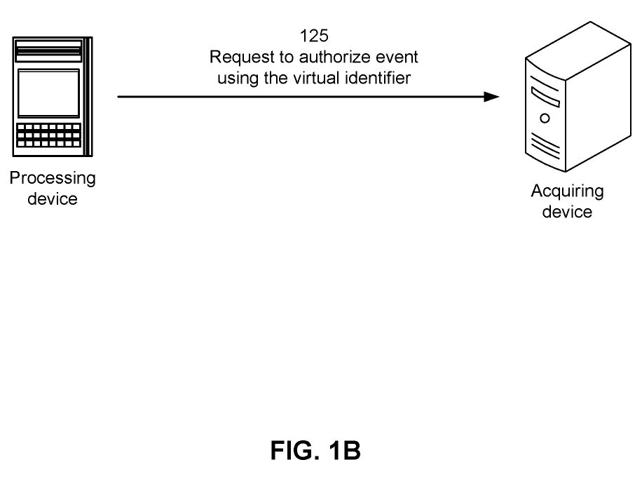

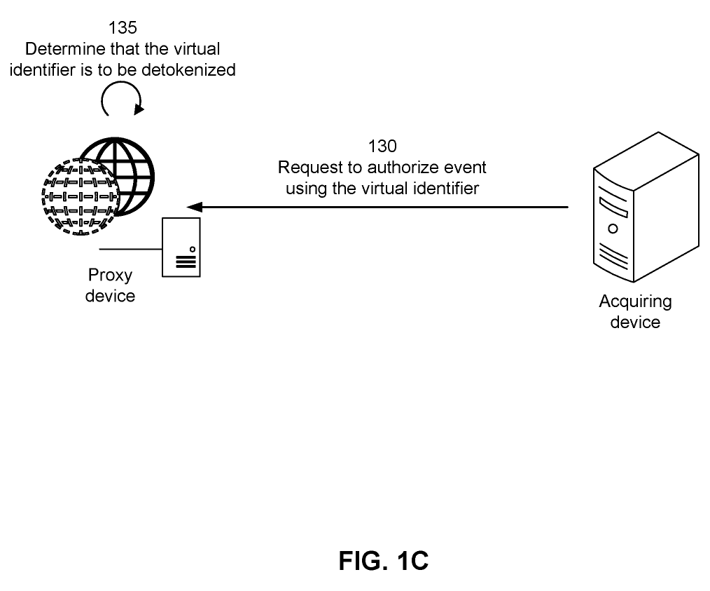

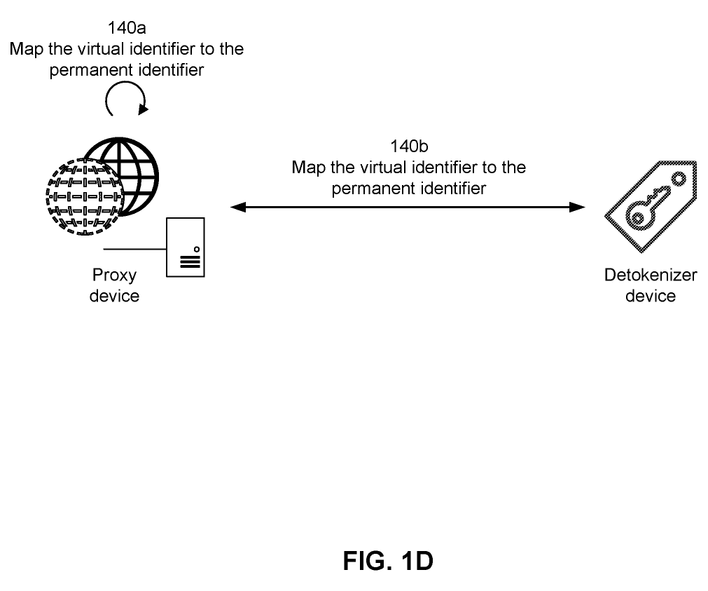

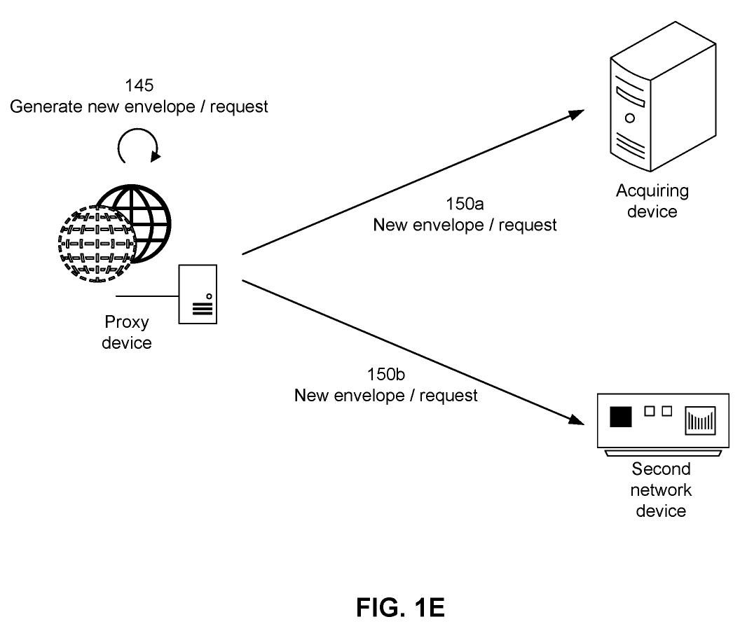

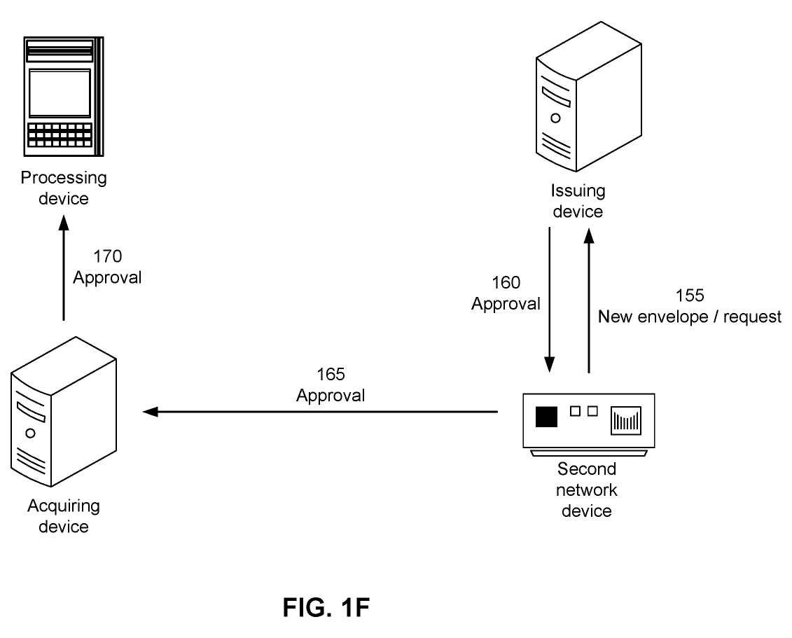

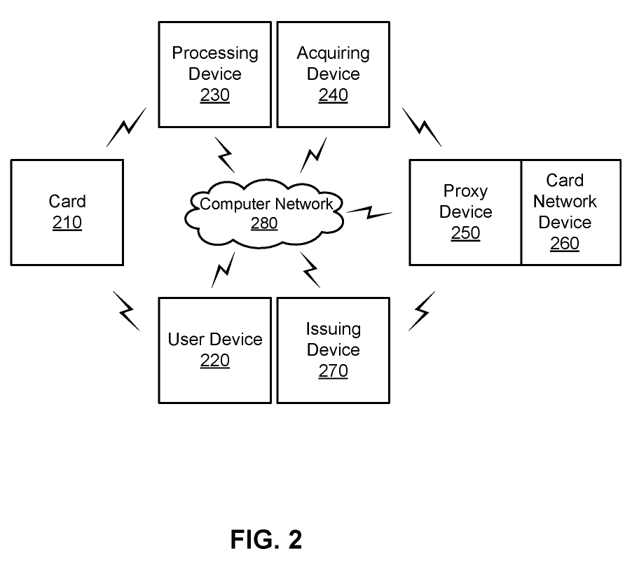

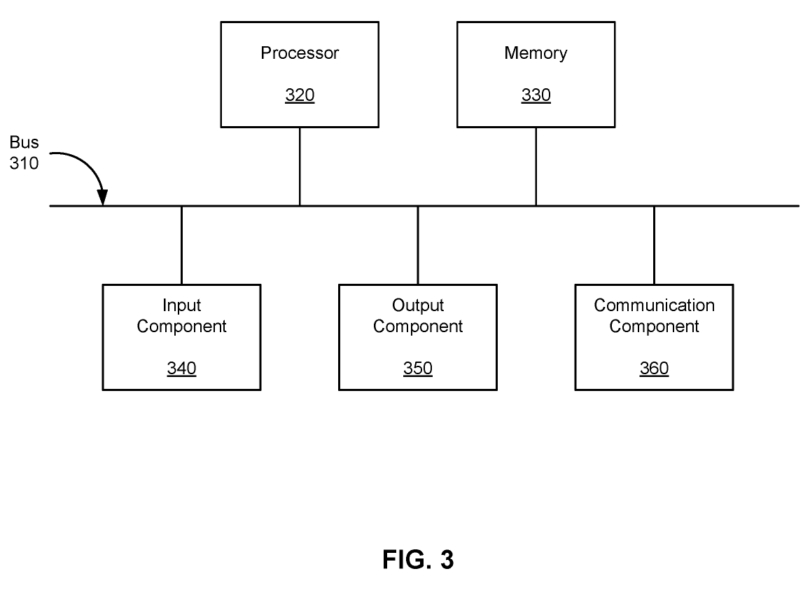

FIGS. 1A-1F are diagrams of an example 100 associated with moving across card networks. As shown in FIGS. 1A-1F, example 100 includes a user device, an issuing device, a detokenizer device, a processing device, an acquiring device, a proxy device, and a second network device (distinct from a first network device, not shown in FIGS. 1A-1F). These devices are described in more detail in connection with FIGS. 2 and 3.

As shown in FIG. 1A and by reference number 105, the user device may transmit, and the issuing device may receive, a request to associate a virtual identifier with a permanent identifier. For example, the request may be a request to link the virtual identifier to the permanent identifier. The request may include a hypertext transfer protocol (HTTP) request and/or an application programming interface (API) call. In some implementations, the user device may include an indication of the permanent identifier (e.g., an encrypted version of the permanent identifier) in a header of, and/or as an argument to, the request. Therefore, the issuing device may validate the permanent identifier (e.g., before processing the request). Additionally, or alternatively, the user device may include a set of credentials with the request. The set of credentials may include a username and password, a passkey, a certificate, a signature, a private key, and/or biometric information, among other examples. Therefore, the issuing device may validate the set of credentials (e.g., before processing the request). In some implementations, the user device may transmit the set of credentials separately from the request. For example, the user device may transmit the set of credentials initially, and the issuing device may accept the request from the user device in response to validating the set of credentials. In another example, the issuing device may prompt the user device in response to the request, and the user device may transmit the set of credentials in response to the prompt. Accordingly, the issuing device may validate the set of credentials and may process the request in response to validating the set of credentials.

In some implementations, a user of the user device may provide input that triggers the user device to transmit the request. For example, a web browser (and/or another type of application executed by the user device) may navigate to a website controlled by (or at least associated with) the issuing device. Accordingly, the user may interact with a user interface (UI) representing the website in order to provide the input to trigger the user device to transmit the request. Alternatively, the user may interact with a text interface (e.g., a command prompt or a shell) in order to provide the input to trigger the user device to transmit the request.

The user device may request that the virtual identifier be associated with a first card network even though the permanent identifier is associated with a second card network (different from the first card network). Therefore, the issuing device may determine to use the detokenizer device that is accessible by (or at least partially integrated with) the proxy device associated with the first card network.

As shown by reference number 110, the issuing device may generate a data structure that stores the virtual identifier in association with the permanent identifier. In some implementations, the issuing device may generate the virtual identifier (e.g., using pseudo-random number generation and/or algorithmic modification of the permanent identifier, among other examples). Alternatively, the request from the user device may indicate (e.g., in a header and/or as an argument) the virtual identifier to use as a substitute for the permanent identifier (e.g., as extracted from a valet card or another type of device already configured to use the virtual identifier).

In one example, the data structure may include a table or another type of relational data structure that associates the virtual identifier with the permanent identifier. Therefore, the data structure may be queried using structured query language (SQL). In another example, the data structure may include a graph data structure or another type of NoSQL data structure.

As shown by reference number 115, the issuing device may transmit, and the detokenizer device may receive, the data structure. Therefore, the detokenizer device may use the data structure to detokenize the virtual identifier (e.g., in response to a request from an authorized device, such as the proxy device). In some implementations, the issuing device may additionally transmit, and the proxy device may receive, an indication that the data structure was sent to the detokenizer device. Therefore, the proxy device may be aware that the virtual identifier may be detokenized by the detokenizer device. Additionally, or alternatively, the issuing device may transmit, and the proxy device may receive, the data structure. Therefore, the proxy device may perform operations that the detokenizer device performs. For example, the detokenizer device may be at least partially integrated (e.g., virtually, logically, and/or physically) with the proxy device.

As shown by reference number 120, the issuing device may transmit, and the user device may receive, a confirmation that the virtual identifier was linked to the permanent identifier. For example, the issuing device may transmit the confirmation in response to an acknowledgement of the data structure from the detokenizer device and/or the proxy device. The confirmation may be text-based or may include instructions for a UI. The user device may output the confirmation to the user (e.g., via an output component of the user device).

As shown in FIG. 1B, the user (or a person authorized by the user) may use the virtual identifier at the processing device. Accordingly, the processing device may transmit, and the acquiring device may receive, a request to authorize an event using the virtual identifier, as shown by reference number 125. The event may be a transaction or another type of event. The request may include a data structure (e.g., a comma separated values (CSV) file or another type of delimiter separated values (DSV) file, an extensible markup language (XML) file, and/or a JavaScript^{®} object notation (JSON) file, among other examples) encoding the event associated with the virtual identifier. In some implementations, the processing device may include an indication of the virtual identifier (e.g., an encrypted version of the virtual identifier) in a header of, and/or as an argument to, the request.

As shown in FIG. 1C, the acquiring device may route the request to the first card network (e.g., because the virtual identifier is associated with the first card network). For example, a portion of the virtual identifier (e.g., an initial digit, a terminating digit, or another portion of the virtual identifier) may be associated with the first card network. The acquiring device may use a data structure (e.g., stored locally at the acquiring device or remotely accessed by the acquiring device) to map the portion of the virtual identifier to an indication of the first card network (e.g., a name of the first card network, an Internet protocol (IP) address of the first card network device, and/or a medium access control (MAC) address of the first card network device, among other examples). Therefore, the acquiring device may forward the request (e.g., directly or by reencoding information from the request into a new envelope) to the first card network device (not shown in FIGS. 1A-1F). Because the proxy device is configured to receive requests on behalf of the first card network, the proxy device may receive the request from the acquiring device, as shown by reference number 130.

As shown by reference number 135, the proxy device may determine that the virtual identifier is to be detokenized. For example, a portion of the virtual identifier (e.g., an initial digit, a terminating digit, or another type of indicator included in the virtual identifier) may indicate that the virtual identifier is virtual (and not permanent). The proxy device may use a data structure (e.g., stored locally at the proxy device or remotely accessed by the proxy device) to map the portion of the virtual identifier to an indication that the virtual identifier is to be detokenized.

As shown in FIG. 1D, the proxy device may detokenize the virtual identifier in order to obtain the permanent identifier. For example, as shown by reference number 140a, the proxy device may map the virtual identifier to the permanent identifier. In some implementations, the proxy device may use a data structure (e.g., stored in a cache or another local memory controlled by the proxy device), storing virtual identifiers in association with permanent identifiers, to map the virtual identifier to the permanent identifier. The data structure may have been received from the issuing device (e.g., as described in connection with FIG. 1A). Additionally, or alternatively, the proxy device may apply an algorithm to convert the virtual identifier into the permanent identifier. The algorithm may have been indicated by the issuing device (e.g., indicated by the data structure described in connection with FIG. 1A).

In another example, as shown by reference number 140b, the proxy device may communicate with the detokenizer device to map the virtual identifier to the permanent identifier. For example, the proxy device may transmit, and the detokenizer device may receive, a request for the permanent identifier that indicates the virtual identifier (e.g., in a header and/or as an argument). Accordingly, the detokenizer device may transmit, and the proxy device may receive, a response, to the request, that indicates the permanent identifier. In some implementations, the proxy device may determine the detokenizer device to contact. For example, a portion of the virtual identifier (e.g., an initial digit, a terminating digit, or another type of indicator included in the virtual identifier) may indicate the detokenizer device (from a plurality of possible detokenizer devices). The proxy device may use a data structure (e.g., stored locally at the proxy device or remotely accessed by the proxy device) to map the portion of the virtual identifier to an indication of the detokenizer device to use.

By detokenizing at the proxy device rather than at the issuing device, the permanent identifier may be associated with a different card network than the virtual identifier. As a result, security is increased because more combinations of virtual identifiers and permanent identifiers may be used.

As shown in FIG. 1E and by reference number 145, the proxy device may generate a new request and/or envelope using the permanent identifier. For example, the proxy device may replace the virtual identifier in the request (from the acquiring device) with the permanent identifier in order to generate a detokenized request. Additionally, or alternatively, the proxy device may reencode the request (from the acquiring device) into an envelope using the permanent identifier instead of the virtual identifier.

In some implementations, the envelope and/or the detokenized request may indicate (e.g., in a header) the proxy device as a source. For example, the envelope and/or the detokenized request may include an identifier of the proxy device (e.g., a name, an IP address, and/or a MAC address, among other examples). Alternatively, the envelope and/or the detokenized request may be transparent to the second card network (e.g., by refraining from indicating the proxy device as a source). Accordingly, rather than indicating the proxy device as a source, the envelope and/or the detokenized request may indicate the acquiring device as a source.

As shown by reference number 150a, the proxy device may transmit, and the acquiring device may receive, the envelope and/or the detokenized request. For example, the proxy device may return the request (in detokenized and/or reencoded form) for the acquiring device to route to the second card network. Alternatively, as shown by reference number 150b, the proxy device may transmit, and the second card network device may receive, the envelope and/or the detokenized request for processing. Accordingly, the proxy device may continue processing of the request transparently to the acquiring device.

As shown in FIG. 1F and by reference number 155, the second card network device may forward the envelope and/or the detokenized request (e.g., directly or by reencoding information from the envelope and/or the detokenized request into a new envelope) to the issuing device. The issuing device may authorize the event (e.g., process a transaction according to the request) and may transmit an approval of the event to the second card network device, as shown by reference number 160. As shown by reference number 165, the second card network device may forward the approval (e.g., directly or by reencoding information from the approval into a new envelope) to the acquiring device. As shown by reference number 170, the acquiring device may forward the approval (e.g., directly or by reencoding information from the approval into a new envelope) to the processing device. In some implementations, the processing device may output the approval to a user (e.g., via an output component of the processing device) and/or may forward the approval (e.g., directly or by reencoding information from the approval into a new envelope) to the user device.

By using techniques as described in connection with FIGS. 1A-1F, the proxy device detokenizes the virtual identifier into the permanent identifier before the request from the processing device is routed through the first card network. Therefore, the proxy device may route the request to the second card network after detokenization. As a result, security is improved because the virtual identifier may be associated with a different card network than a card network associated with the permanent identifier.

As indicated above, FIGS. 1A-1F are provided as an example. Other examples may differ from what is described with regard to FIGS. 1A-1F.

FIG. 2 is a diagram of an example environment 200 in which systems and/or methods described herein may be implemented. As shown in FIG. 2, environment 200 may include a card 210, a user device 220, a processing device 230, an acquiring device 240, a proxy device 250, a card network device 260, an issuing device 270, and/or a computer network 280. Devices of environment 200 may interconnect via wired connections and/or wireless connections.

The card 210 may include one or more devices capable of being used for an electronic transaction. In some implementations, the card 210 may include a transaction card (or another physical medium with integrated circuitry) capable of storing and communicating account information, such as a credit card, a debit card, a gift card, an automated teller machine (ATM) card, a transit card, a fare card, and/or an access card. In some implementations, the card 210 may be integrated into the user device 220. For example, the user device 220 may execute an electronic payment application capable of performing functions of the card 210 described herein. The card 210 may store account information, which may be used in connection with an electronic transaction facilitated by the processing device 230. The account information may include, for example, an account identifier (e.g., an account number, a card number, a bank routing number, and/or a bank identifier) that identifies an account (e.g., a bank account or a credit account), a cardholder identifier (e.g., identifying a name of a person, business, or entity), expiration information (e.g., identifying an expiration month and/or an expiration year), and/or a credential (e.g., a payment token). In some implementations, the card 210 may store the account information in tamper-resistant memory of the card 210, such as in a secure element. As part of performing an electronic transaction, the card 210 may transmit the account information to the processing device 230 using a communication component, such as a magnetic stripe, an integrated circuit (IC) chip (e.g., a EUROPAY®, MASTERCARD®, VISA® (EMV) chip), and/or a contactless communication component (e.g., a near field communication (NFC) component, a radio frequency (RF) component, a Bluetooth® component, and/or a Bluetooth Low Energy (BLE) component). Thus, the card 210 and the processing device 230 may communicate with one another by coming into contact with one another (e.g., using a magnetic stripe or an EMV chip) or via contactless communication (e.g., using NFC).

The user device 220 may include one or more devices capable of being used for an electronic transaction (e.g., as described above in connection with the card 210). The user device 220 may include a communication device and/or a computing device. For example, the user device 220 may include a wireless communication device, a mobile phone, a user equipment, a tablet computer, a wearable communication device (e.g., a smart wristwatch, a pair of smart eyeglasses, a head mounted display, or a virtual reality headset), or a similar type of device. Additionally, or alternatively, the user device 220 may be capable of receiving, generating, storing, processing, and/or providing information associated with virtual identifiers, as described elsewhere herein. The user device 220 may communicate with one or more other devices of environment 200, as described elsewhere herein.

The processing device 230 may include one or more devices capable of facilitating an event (e.g., an electronic transaction). For example, the processing device 230 may include a point-of-sale (PoS) terminal, a payment terminal (e.g., a credit card terminal, a contactless payment terminal, a mobile credit card reader, or a chip reader), and/or an ATM. In some implementations, the processing device 230 may include a server associated with electronic transactions (e.g., a cloud-based payment terminal). The processing device 230 may include one or more input components and/or one or more output components to facilitate obtaining data (e.g., account information) from the card 210 and/or the user device 220 or to otherwise facilitate interaction with and/or authorization from an owner or accountholder. Example input components of the processing device 230 include a network interface card (NIC), a number keypad, a touchscreen, a magnetic stripe reader, a chip reader, and/or an RF signal reader (e.g., an NFC reader). Example output components of the processing device 230 include the NIC, a display, and/or a speaker. The processing device 230 may communicate with one or more other devices of environment 200, as described elsewhere herein.

The acquiring device 240 may include one or more devices capable of receiving, generating, storing, processing, and/or providing information associated with events (e.g., transactions), as described elsewhere herein. The acquiring device 240 may process events (e.g., transactions) from the processing device 230. The acquiring device 240 may include a communication device and/or a computing device. For example, the acquiring device 240 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The acquiring device 240 may communicate with one or more other devices of environment 200, as described elsewhere herein.

The proxy device 250 may include one or more devices capable of receiving, processing, storing, routing, and/or providing traffic (e.g., event requests) in a manner described herein. For example, the proxy device 250 may include a router, a switch, a hub, a bridge, a reverse proxy, a server (e.g., a proxy server, a cloud server, or a data center server), and/or a similar device. In some implementations, the proxy device 250 may be a virtual device implemented by one or more computing devices of a cloud computing environment or a data center. The proxy device 250 may forward requests from the acquiring device 240 to the card network device 260 (or to a different card network, whether via the acquiring device 240 or directly). The proxy device 250 may communicate with one or more other devices of environment 200, as described elsewhere herein.

The card network device 260 may include one or more devices capable of receiving, processing, storing, routing, and/or providing traffic (e.g., event requests) in a manner described herein. For example, the card network device 260 may include a router, a switch, a hub, a bridge, a reverse proxy, a server (e.g., a proxy server, a cloud server, or a data center server), and/or a similar device. In some implementations, the card network device 260 may be associated with Visa, Mastercard, Discover®, and/or American Express®. The card network device 260 may forward requests from the acquiring device 240 (or from the proxy device 250) to the issuing device 270. The card network device 260 may communicate with one or more other devices of environment 200, as described elsewhere herein.

The issuing device 270 may include one or more devices capable of receiving, generating, storing, processing, and/or providing information associated with accounts, as described elsewhere herein. The issuing device 270 may process events (e.g., transactions) associated with an account managed by the issuing device 270 (e.g., based on requests from the card network device 260 or a different card network device). The issuing device 270 may include a communication device and/or a computing device. For example, the issuing device 270 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The issuing device 270 may communicate with one or more other devices of environment 200, as described elsewhere herein.

The computer network 280 may include one or more wired and/or wireless networks. For example, the computer network 280 may include a cellular network, a public land mobile network, a local area network, a wide area network, a metropolitan area network, a telephone network, a private network, the Internet, and/or a combination of these or other types of networks. The computer network 280 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with moving across card networks. The device 300 may correspond to a user device 220, a processing device 230, an acquiring device 240, a proxy device 250, a card network device 260, and/or an issuing device 270. In some implementations, a user device 220, a processing device 230, an acquiring device 240, a proxy device 250, a card network device 260, and/or an issuing device 270 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

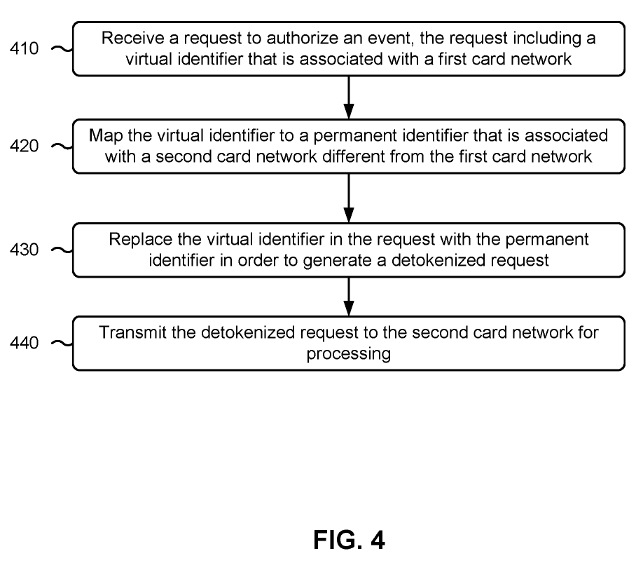

FIG. 4 is a flowchart of an example process 400 associated with moving across card networks. In some implementations, one or more process blocks of FIG. 4 may be performed by a proxy device 250. In some implementations, one or more process blocks of FIG. 4 may be performed by another device or a group of devices separate from or including the proxy device 250, such as a user device 220, a processing device 230, an acquiring device 240, a card network device 260, and/or an issuing device 270. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a request to authorize an event, the request including a virtual identifier that is associated with a first card network (block 410). For example, the proxy device 250 (e.g., using processor 320, memory 330, and/or communication component 360) may receive a request to authorize an event, the request including a virtual identifier that is associated with the first card network, as described above in connection with reference number 130 of FIG. 1C. As an example, the proxy device 250 may be configured to receive requests on behalf of the first card network. Accordingly, the proxy device 250 may receive the request from an acquiring device.

As further shown in FIG. 4, process 400 may include mapping the virtual identifier to a permanent identifier that is associated with a second card network different from the first card network (block 420). For example, the proxy device 250 (e.g., using processor 320, memory 330, and/or communication component 360) may map the virtual identifier to a permanent identifier that is associated with a second card network different from the first card network, as described above in connection with reference number 140a or reference number 140b of FIG. 1D. As an example, the proxy device 250 may use a data structure, storing virtual identifiers in association with permanent identifiers, to map the virtual identifier to the permanent identifier. In another example, the proxy device 250 may apply an algorithm to convert the virtual identifier into the permanent identifier. In another example, the proxy device 250 may communicate with a detokenizer device to map the virtual identifier to the permanent identifier.

As further shown in FIG. 4, process 400 may include replacing the virtual identifier in the request with the permanent identifier in order to generate a detokenized request (block 430). For example, the proxy device 250 (e.g., using processor 320 and/or memory 330) may replace the virtual identifier in the request with the permanent identifier in order to generate a detokenized request, as described above in connection with reference number 145 of FIG. 1E. As an example, the detokenized request may indicate (e.g., in a header) the proxy device 250 as a source. Alternatively, the detokenized request may be transparent to the second card network (e.g., by refraining from indicating the proxy device 250 as a source). Accordingly, rather than indicating the proxy device 250 as a source, the detokenized request may indicate the acquiring device as a source.

As further shown in FIG. 4, process 400 may include transmitting the detokenized request to the second card network for processing (block 440). For example, the proxy device 250 (e.g., using processor 320, memory 330, and/or communication component 360) may transmit the detokenized request to the second card network for processing, as described above in connection with reference number 150a or reference number 150b of FIG. 1E. As an example, the proxy device 250 may transmit the detokenized request to the acquiring device for delivery to the second card network. Alternatively, the proxy device 250 may transmit the detokenized request directly to the second card network (e.g., transparent to the acquiring device).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1F. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

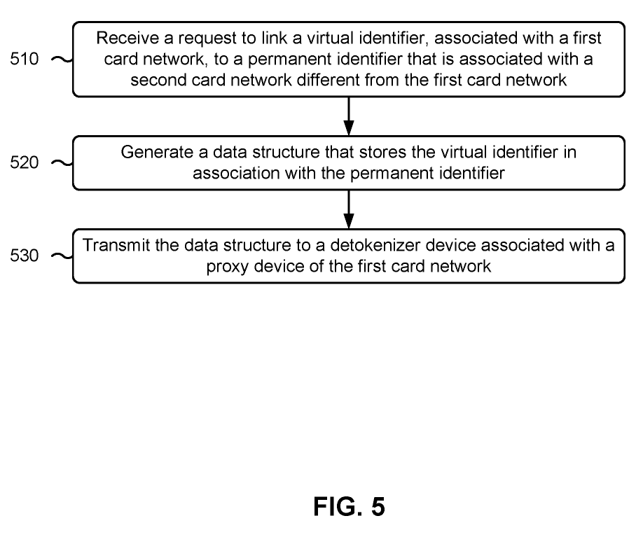

FIG. 5 is a flowchart of an example process 500 associated with generating virtual identifiers across card networks. In some implementations, one or more process blocks of FIG. 5 may be performed by an issuing device 270. In some implementations, one or more process blocks of FIG. 5 may be performed by another device or a group of devices separate from or including the issuing device 270, such as a user device 220, a processing device 230, an acquiring device 240, a proxy device 250, and/or a card network device 260. Additionally, or alternatively, one or more process blocks of FIG. 5 may be performed by one or more components of the device 300, such as processor 320, memory 330, input component 340, output component 350, and/or communication component 360.

As shown in FIG. 5, process 500 may include receiving a request to link a virtual identifier, associated with a first card network, to a permanent identifier that is associated with a second card network different from the first card network (block 510). For example, the issuing device 270 (e.g., using processor 320, memory 330, input component 340, and/or communication component 360) may receive a request to link a virtual identifier, associated with a first card network, to a permanent identifier that is associated with a second card network different from the first card network, as described above in connection with reference number 105 of FIG. 1A. As an example, the issuing device 270 may receive the request from the user device. The request may include an indication of the permanent identifier (e.g., an encrypted version of the permanent identifier), and the issuing device 270 may validate the permanent identifier (e.g., before processing the request). Additionally, or alternatively, the request may include a set of credentials, and the issuing device 270 may validate the set of credentials (e.g., before processing the request).

As further shown in FIG. 5, process 500 may include generating a data structure that stores the virtual identifier in association with the permanent identifier (block 520). For example, the issuing device 270 (e.g., using processor 320 and/or memory 330) may generate a data structure that stores the virtual identifier in association with the permanent identifier, as described above in connection with reference number 110 of FIG. 1A. As an example, the issuing device 270 may generate the virtual identifier (e.g., using pseudo-random number generation and/or algorithmic modification of the permanent identifier, among other examples). Alternatively, the request may indicate the virtual identifier for the issuing device 270 to use (e.g., as extracted from a valet card or another type of device already configured to use the virtual identifier).

As further shown in FIG. 5, process 500 may include transmitting the data structure to a detokenizer device associated with a proxy device of the first card network (block 530). For example, the issuing device 270 (e.g., using processor 320, memory 330, and/or communication component 360) may transmit the data structure to a detokenizer device associated with a proxy device of the first card network, as described above in connection with reference number 115 of FIG. 1A. As an example, the detokenizer device may be at least partially integrated (e.g., virtually, logically, and/or physically) with a proxy device. Alternatively, the issuing device 270 may also transmit the data structure to the proxy device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1F. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for routing requests across card networks, the system comprising:
one or more memories; and
one or more processors, communicatively coupled to the one or more memories, configured to:
receive a request to authorize an event, wherein the request includes a virtual identifier that is associated with a first card network, wherein the system is configured to receive requests on behalf of the first card network;
map the virtual identifier to a permanent identifier that is associated with a second card network different from the first card network;
reencode the request into an envelope, using the permanent identifier instead of the virtual identifier, that is transparent to the second card network; and
transmit the envelope to the second card network for processing.

2. The system of claim 1, wherein the envelope is transparent to the second card network by refraining from indicating the system, associated with the first card network, as a source for the envelope.

3. The system of claim 1, wherein the one or more processors, to map the virtual identifier to the permanent identifier, are configured to:
use a data structure, stored in the one or more memories, that stores virtual identifiers in association with permanent identifiers.

4. The system of claim 3, wherein the one or more processors are configured to:
receive the data structure from an issuing device.

5. The system of claim 1, wherein the one or more processors, to map the virtual identifier to the permanent identifier, are configured to:
identify an indicator, included in the virtual identifier, that the virtual identifier is to be detokenized;
transmit, to a detokenizer device, a request for the permanent identifier that indicates the virtual identifier; and
receive, from the detokenizer device, a response to the request that indicates the permanent identifier.

6. The system of claim 5, wherein the indicator is associated with the detokenizer device from a plurality of possible detokenizer devices.

7. The system of claim 1, wherein the request is received from an acquiring device, and the envelope indicates the acquiring device as a source.

8. A method of routing requests across card networks, comprising:
receiving, at a proxy device configured to receive requests on behalf of a first card network, a request to authorize an event, wherein the request includes a virtual identifier that is associated with the first card network;
mapping, by the proxy device, the virtual identifier to a permanent identifier that is associated with a second card network different from the first card network;
replacing, by the proxy device, the virtual identifier in the request with the permanent identifier in order to generate a detokenized request; and
transmitting, from the proxy device, the detokenized request to the second card network for processing.

9. The method of claim 8, wherein transmitting the detokenized request to the second card network comprises:
transmitting the detokenized request to an acquiring device for delivery to the second card network.

10. The method of claim 8, wherein mapping the virtual identifier to the permanent identifier comprises:
applying an algorithm, by the proxy device, to convert the virtual identifier into the permanent identifier.

11. The method of claim 8, wherein mapping the virtual identifier to the permanent identifier comprises:
determining, using the virtual identifier, a detokenizer device;
transmitting, to the detokenizer device, a request for the permanent identifier that indicates the virtual identifier; and
receiving, from the detokenizer device, a response to the request that indicates the permanent identifier.

12. The method of claim 8, wherein the request is received from an acquiring device, and the detokenized request indicates the acquiring device as a source.

13. The method of claim 8, wherein the detokenized request indicates the proxy device as a source.

14. A non-transitory computer-readable medium storing a set of instructions for generating a virtual identifier that routes across card networks, the set of instructions comprising:
one or more instructions that, when executed by one or more processors of a device, cause the device to:
receive a request to link a virtual identifier, associated with a first card network, to a permanent identifier that is associated with a second card network different from the first card network;
generate a data structure that stores the virtual identifier in association with the permanent identifier; and
transmit the data structure to a detokenizer device associated with a proxy device of the first card network.

15. The non-transitory computer-readable medium of claim 14, wherein the detokenizer device is at least partially integrated with the proxy device.

16. The non-transitory computer-readable medium of claim 14, wherein the one or more instructions, when executed by the one or more processors, cause the device to:
transmit, to the proxy device, an indication that the data structure was sent to the detokenizer device.

17. The non-transitory computer-readable medium of claim 14, wherein the one or more instructions, that cause the device to receive the request to link the virtual identifier to the permanent identifier, cause the device to:
receive the request from a user device.

18. The non-transitory computer-readable medium of claim 17, wherein the one or more instructions, when executed by the one or more processors, cause the device to:
receive, from the user device, a set of credentials,
wherein the request is received based on verifying the set of credentials.

19. The non-transitory computer-readable medium of claim 14, wherein the one or more instructions, when executed by the one or more processors, cause the device to:
validate the permanent identifier,
wherein the data structure is generated in response to validating the permanent identifier.

20. The non-transitory computer-readable medium of claim 14, wherein the one or more instructions, when executed by the one or more processors, cause the device to:
transmit, to a user device, a confirmation that the virtual identifier was linked to the permanent identifier.
